(19) United States
(12) Patent Application Publication
(10) Pub. No.: US 2018/0226718 A1
(43) Pub. Date: Aug. 9, 2018

(54) INTEGRATED ANTENNA MOUNTING

(71) Applicant: TAOGLAS GROUP HOLDINGS LIMITED, Enniscorthy (IE)

(72) Inventor: Christopher M. ANDERSON, Minneapolis, MN (US)

(73) Assignee: TAOGLAS GROUP HOLDINGS LIMITED, Enniscorthy (IE)

(21) Appl. No.: 15/428,425

(22) Filed: Feb. 9, 2017

(51) Int. Cl. H01Q 9/04; H01Q 1/38; H01Q 1/48; H01Q 13/28

(52) U.S. Cl. CPC H01Q 9/045; H01Q 1/38; H01Q 13/28; H01Q 9/0485; H01Q 1/48

(57) ABSTRACT

Disclosed are devices and methods wherein antenna radiator plate, dielectric material and mounting structure(s) are incorporated into a single unified structure which enables the device to be mounted upon a electronic device body or surface while maintaining a gap between the surface of the host and the body of the device. By not interfering with existing electronics and components on the surface of the host, this enables installation onto without requiring dedicated space, additional surface area, or special brackets or fixtures.

### BACKGROUND

### Field

The present disclosure relates in general to an antenna and, in particular, to a patch antenna.

### Background

Patch antennas often use dielectric materials of ceramic or incorporate an air gap between the radiator element and the ground plane beneath the radiator element. Typically, when integrating such antennas into electronic devices, adhesive mounting to the surface of a printed circuit board is employed. This requires dedicated space on the electronic device body. Alternately, external brackets or fixtures may be used to mount the antenna onto a second printed circuit board. Neither of these practices is optimal from a design and manufacturing cost standpoint.

What is needed is an antenna that integrates structural mounting elements into the body of the dielectric material, enabling installation of the antenna above a target surface of the electronic device, thus obviating the need for a dedicated mounting surface or additional mounting hardware.

### SUMMARY

By supporting the radiating patch of the antenna in a dielectric structure with integrated mounting features, the disclosed system eliminates the need to either dedicate additional space on printed circuit board electronics, or provide a second add-on printed circuit board, or to create custom brackets when incorporating a patch antenna into existing electronics.

An aspect of the disclosure is directed to patch antennas. Suitable patch antennas comprise: a radiator housing having an upper surface, a lower surface, and four sides between the upper surface and lower surface wherein the upper surface faces away from an installation substrate and the lower surface faces towards the installation substrate when installed; a radiator plate on the upper surface of the radiator housing; a feed pin which passes through the radiator housing and terminates in a feed pin head on the upper surface of the radiator housing; a leg which extends from the radiator housing beyond the lower surface of the radiator housing wherein the length of the leg creates a gap between the lower surface of the radiator housing and a bottom of the leg. The leg can further comprise a first offset leg, a second offset leg, and a third offset leg which extend from the radiator housing beyond the lower surface of the radiator housing wherein two of the offset legs extend from the radiator housing at a location along a first axis and the third offset leg extends from the radiator housing a location along a second axis which is parallel to the first axis. In other configurations, the leg is a skirt that extends from the radiator housing about an exterior. In some configurations, the radiator housing is formed from a dielectric material. Additionally, one or more of feet, standoffs, posts, and bosses can be provided. When installed, a gap is created between the lower surface of the radiator housing and a bottom of the offset legs. One or more threaded fasteners which pass through an aperture in the offset leg can be provided to secure the patch antenna to the installation substrate. Additionally, a ground plane element positioned adjacent the lower surface of the radiator housing can be provided. The three offset legs can pass through a corresponding aperture of the ground plane element. When installed, the patch antenna engages an electronic device, e.g., via a coaxial cable.

Another aspect of the disclosure is directed to a method of installing a patch antennas. Suitable methods comprise: providing the patch antenna comprising a radiator housing having an upper side and a lower side where the upper side faces away from a PCB and the lower side faces towards the PCB when installed, a radiator plate on the upper surface of the radiator housing, a feed pin which passes through the radiator housing and terminates in a feed pin head on the upper surface of the radiator housing, a leg which extends from the radiator housing beyond the lower surface of the radiator housing wherein the leg creates a gap between the lower surface of the radiator housing and a bottom of the leg. Methods can further comprise securing the patch antenna to the substrate with a threaded fastener. Additionally, the patch antenna can be secured to the substrate with an adhesive, or via a press-fit or friction-fit. Additionally, a ground plane element can be positioned adjacent the radiator housing prior to securing the patch antenna to the substrate.

Still another aspect of the disclosure is directed to patch antennas comprising: a radiator housing means having an upper surface, a lower surface, and four sides between the upper surface and lower surface wherein the upper surface faces away from an installation substrate means and the lower surface faces towards the installation substrate means when installed; a radiator plate on the upper surface of the radiator housing means; a feed pin which passes through the radiator housing means and terminates in a feed pin head on the upper surface of the radiator housing means; a leg which extends from the radiator housing beyond the lower surface of the radiator housing wherein the leg creates a gap between the lower surface of the radiator housing and a bottom of the leg. The radiator housing means can be formed from a dielectric material. Additionally, one or more of feet, standoffs, posts, and bosses can be provided. When installed a gap is formed between the lower surface of the radiator housing means and a bottom of the offset leg. Additionally, in some configurations, one or more threaded fasteners which pass through an aperture in the offset leg can be provided. A ground plane element can also be positioned adjacent the lower surface of the radiator housing means. The three offset legs can pass through a corresponding aperture of the ground plane element. Once installed, the patch antenna engages an electronic device, e.g. via a coaxial cable.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example,

US 2003/0201939 A1 published Oct. 30, 2003, to Reece, et al. for Integrated dual or quad band communication and GPS band antenna;

US 2014/0375527 A1 published Dec. 25, 2014, to Rutfors for Antenna arrangement;

US 2015/0364815 A1 published Dec. 17, 2015, to Yong, et al. for Electronic device with patch antenna;

US 2016/0028148 A1 published Jan. 28, 2016, to Tan, et al. for Electronic device printed circuit board patch antenna;

U.S. Pat. No. 6,538,605 B2 issued Mar. 25, 2003, to Lebaric et al. for Method and system for mounting a monopole antenna;

U.S. Pat. No. 6,914,564 B2 issued Jul. 5, 2005, to Barras et al. for Watchband antenna;

U.S. Pat. No. 7,821,460 B2 issued Oct. 26, 2010, to Schillmeier et al. for Tunable patch antenna of planar construction;

U.S. Pat. No. 8,446,322 B2 issued May 21, 2013, to Tatarnikov et al. for Patch antenna with capacitive elements;

U.S. Pat. No. 8,570,224 B2 issued Oct. 29, 2013, to Mattis for Apparatus providing thermal management for radio frequency devices;

U.S. Pat. No. 8,791,864 B2 issued Jul. 29, 2014, to Merz, et al. for Antenna structures with electrical connections to device housing members; and

U.S. Pat. No. 9,391,370 B2 issued Jul. 12, 2016, to Tzanidis, et al. for Antenna feed integrated on multi-layer PCB.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a patch antenna assembly with offset legs mounted on a printed circuit board (PCB) as viewed from above;

FIG. 1B illustrates a patch antenna assembly with offset legs as viewed from the bottom;

FIG. 1C illustrates a patch antenna assembly with offset legs mounted on a printed circuit board as viewed from the side;

FIG. 1D is an isometric drawing of a patch antenna assembly with offset legs mounted on a printed circuit board;

FIG. 2A illustrates a patch antenna assembly with offset legs and attached ground plane mounted on a printed circuit board as viewed from above;

FIG. 2B illustrates a patch antenna assembly with offset legs and attached ground plane as viewed from below;

FIG. 2C illustrates a patch antenna assembly with offset legs and attached ground plane mounted on a printed circuit board as viewed from the side;

FIG. 2D is an isometric drawing of a patch antenna assembly with offset legs and attached ground plane mounted on a printed circuit board;

FIG. 3A illustrates a patch antenna assembly with snap-fit offset legs as viewed from above;

FIG. 3B illustrates a patch antenna assembly with snap-fit offset legs as viewed from below;

FIG. 3C illustrates a patch antenna assembly with snap-fit offset legs as viewed from the side;

FIG. 3D is an isometric drawing of a patch antenna assembly with snap-fit offset legs;

FIGS. 4A-B illustrate a patch antenna assembly with two legs; and

FIGS. 5A-B illustrate a patch antenna assembly with an elevating skirt around an exterior.

### DETAILED DESCRIPTION

Disclosed is a patch antenna that integrates suitable mechanical mounting elements, such as feet clips standoffs, posts, bosses or other features, into the body of the antenna's dielectric material facilitating the securement of an antenna to an installation substrate or surface, such as PCB or other electronic device surface, via a suitable mechanical fastener such as nut-and-bolt, screw or snap-fit; or adhesive, such as double-sided adhesive tape; and resulting in an assembly where the antenna is mounted above the PCB or clear of existing electronic components or other physical features on the PCB or the electronic device. This eliminates the need for creating a separate anchoring device, or allocating additional surface area on the PCB or within the electronic device body for mounting of antenna. Additionally the process of installing the antenna within an electronic device is simplified because the antenna can be mounted above the PCB or clear of electronic components of the electronic device.

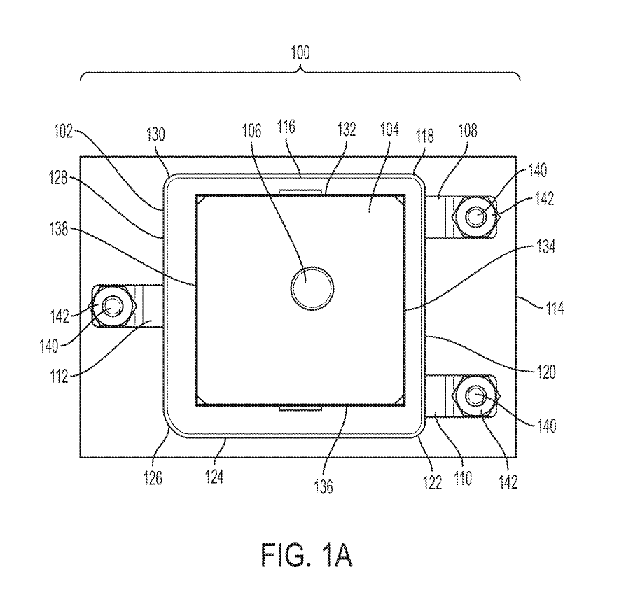

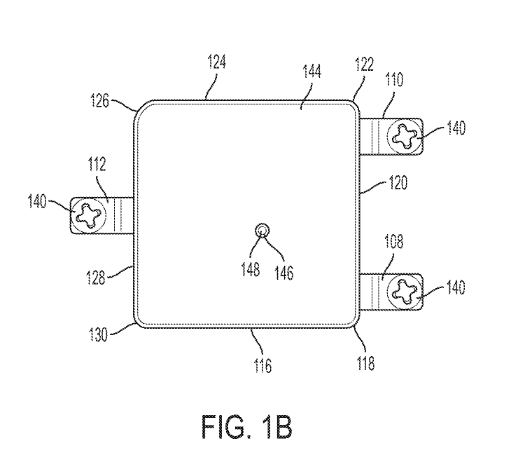

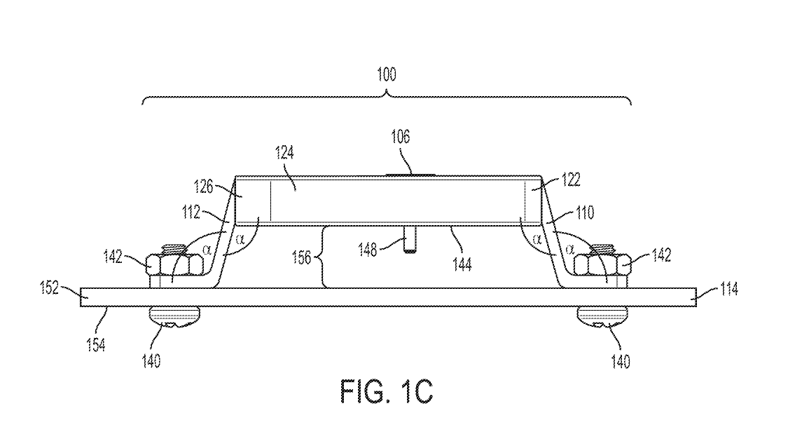

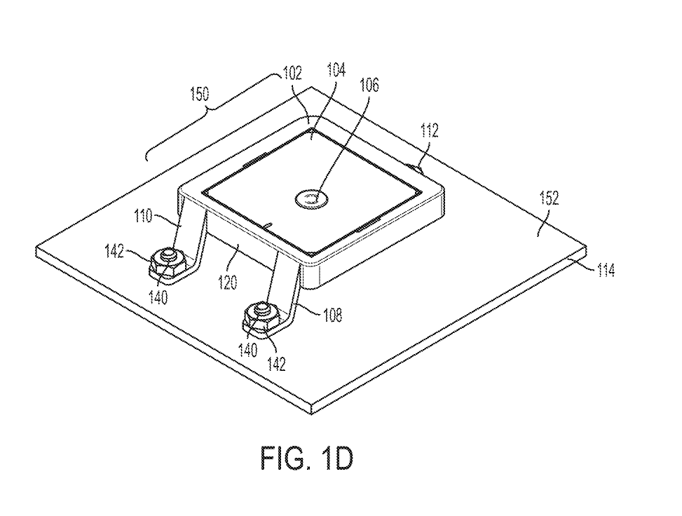

FIG. 1A illustrates an embodiment of the patch antenna of the disclosure as viewed from above when the antenna assembly 100 is connected to an installation substrate such as a PCB 114. As will be appreciated by those skilled in the art, “above” is a relative term and does not limit the position of the antenna assembly relative to an installation substrate. Antenna assembly 100 comprises a radiator housing 102, typically formed of a suitable dielectric material, a radiator plate 104, a feed pin, of which a feed pin head 106 is visible, a first offset leg 108, a second offset leg 110 and a third offset leg 112. In the plan view illustrated, a radiator housing 102 is rectangular with rounded corners with a first housing side 116, a first housing corner 118, a second housing side 120, a second housing corner 122, a third housing side 124, a third housing corner 126, a fourth housing side 128, and a fourth housing corner 130, numbered clockwise as viewed from above. First housing corner 118, second housing corner 122, and fourth housing corner 130 have identical radii, approximately one-sixteenth the length of the first housing side 116. Third housing corner 126 has a radius approximately twice that of the first housing corner 118, second housing corner 122, and fourth housing corner 130. Centrally located within the radiator housing 102 is a radiator plate 104. In the plan view illustrated, the radiator plate 104 is rectangular and includes a first radiator plate side 132, a second radiator plate side 134, a third radiator plate side 136, and a fourth radiator plate side 138. The first radiator plate side 132 runs parallel to and is nearest the first housing side 116; the second radiator plate side 134 runs parallel to and is nearest the second housing side 120; the third radiator plate side 136 runs parallel to and is nearest the third housing side 124; and the fourth radiator plate side 138 runs parallel to and is nearest the fourth housing side 128. Located centrally within the perimeter of the radiator plate 104, is a feed pin head 106, positioned off-center and closer to the first radiator plate side 132 and the second radiator plate side 134 than the third radiator plate side 136 and the fourth radiator plate side 138.

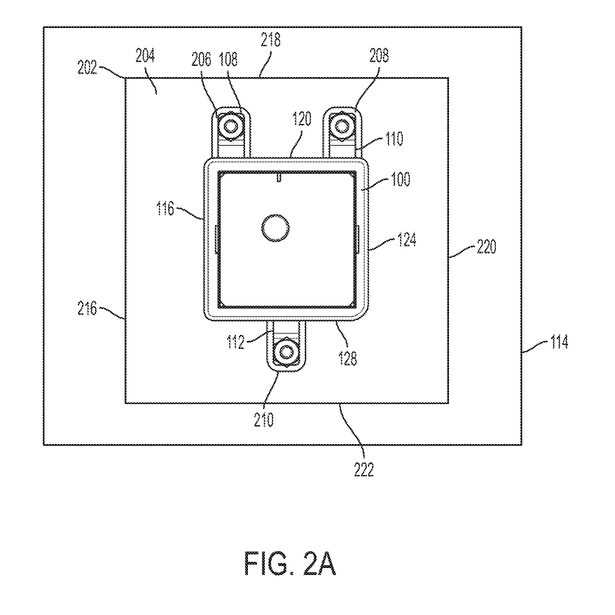

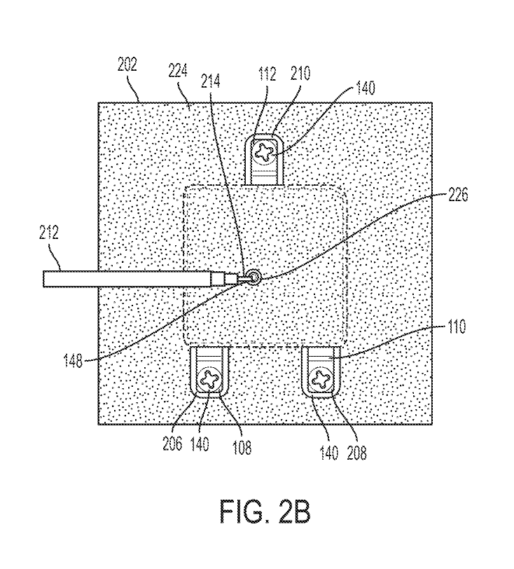

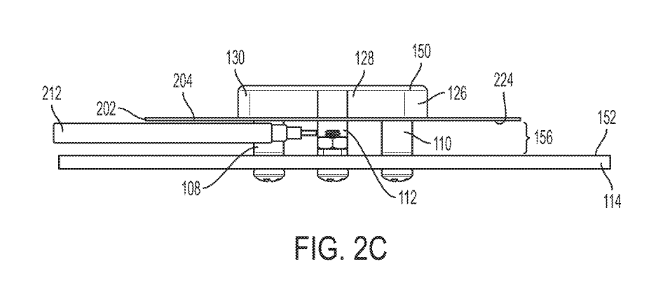

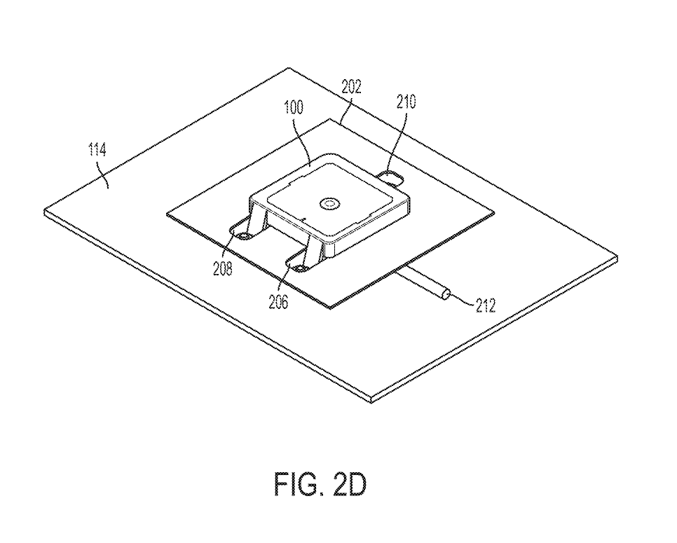

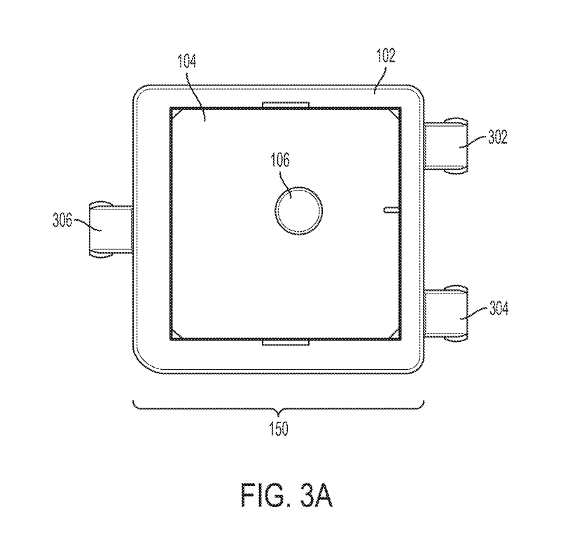

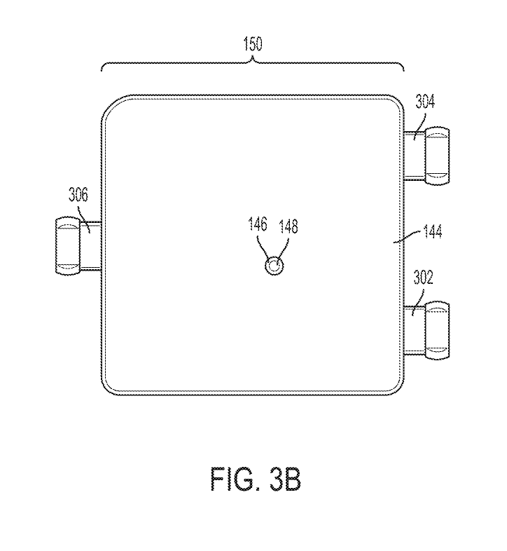

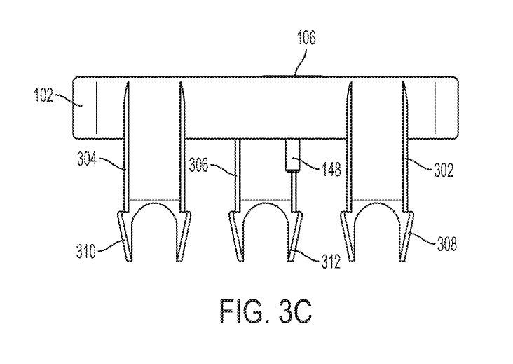

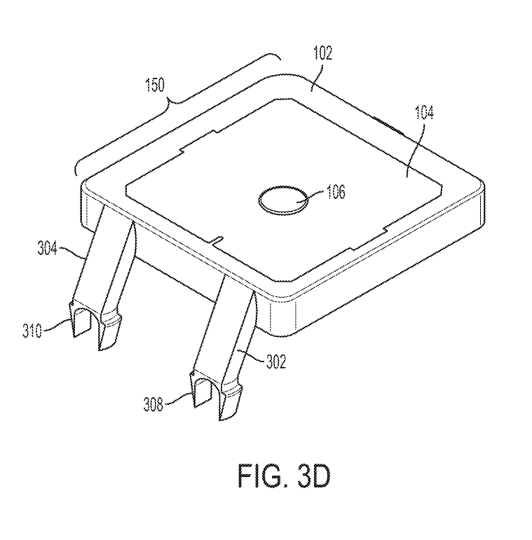

As will be appreciated by those skilled in the art, the offset leg can be “1-shaped” such that the leg has a substantially vertical member and a substantially horizontal member with one of the vertical member and horizontal member being longer than the remaining member. Additionally, the vertical member and horizontal member can, but need not, be at a 90 degree angle. Other angles between the substantially vertical member and the substantially horizontal member can be used without departing from the scope of the disclosure. Additionally, the offset legs can be attached to the side of the radiator housing or extend from the bottom surface of the radiator housing. Moreover, the portion of the offset leg that extends from the radiator housing (either from the side of the housing or the bottom of the housing) can be the shorter of the vertical and horizontal member or the longer of the horizontal member. Additionally, the offset legs can extend from the radiator housing at a 90 degree angle or any other suitable angle. In some configurations, the legs need not be offset. As depicted in FIGS. 1-2, the l-shaped offset leg has a longer member which is the vertical member and depicted engaging the side of the radiator housing and extending from the side of the radiator housing at an angle. As shown in FIG. 3 the snap-fit legs are also depicted engaging the side of the radiator housing and extending downward to the installation substrate at an angle.

In other configurations, one or more legs are provided which need not be offset. The legs can be on one or more sides of the device. The legs can be wide or narrow. For example, the a leg can span the entire length of a side, or can form a skirt around the perimeter of the housing. The legs can also include slots or apertures through which a coaxial cable passes.

As viewed from above, a first offset leg 108 and a second offset leg 110 extend perpendicular from the second housing side 120. First offset leg 108 is located near the first housing corner 118; second offset leg 110 is located near the second housing corner 122. Located opposite the second housing side 120, the third offset leg 112 extends perpendicularly from approximately the center of the fourth housing side 128, as viewed from above. As such, the first offset leg 108, second offset leg 110, and third offset leg 112 are positioned in separate axis that are perpendicular to the second housing side 120, for example. The offset legs form a base upon which the radiator housing 102 rests, such as a tripod base. The offset legs create a space beneath the second housing side 120 for existing electronics and componentry on a surface of the electronic device.

The antenna assembly 100 can be secured to an installation substrate such as PCB 114 via a plurality of bolts 140, each of which passes through a mating aperture in the PCB 114 that correspond to apertures in the first offset leg 108, second offset leg 110 and third offset leg 112.

FIG. 1B illustrates an embodiment of the patch antenna of the disclosure as viewed from below. Evident are features described in FIG. 1A, including first housing side 116, first housing corner 118, second housing side 120, second housing corner 122, third housing side 124, third housing corner 126, fourth housing side 128, fourth housing corner 130, first offset leg 108, second offset leg 110, third offset leg 112 as well as bolts 140 for attachment. Bottom radiator housing surface 144 is planar or substantially planar. Centrally located on bottom radiator housing surface 144 is a feed pin aperture 146, through which a feed pin shank 148 passes. The feed pin provides a point to establish connection between radiator plate 104 (FIG. 1A) and external electronics. The external electronics can be any electronic device configured to communicate with an antenna assembly.

FIG. 1C illustrates an embodiment of the patch antenna of the disclosure as viewed from the side. Evident are elements described in FIG. 1A and FIG. 1B, including feed pin head 106, feed pin shank 148, second housing corner 122, third housing side 124, third housing corner 126, second offset leg 110, and third offset leg 112. Each of the offset legs extends from its respective mating side downward. First offset leg 108 (FIG. 1A) and second offset leg 110 extend from second housing side 120; and third offset leg 112 extends from fourth housing side 128, forming angle α, between each of first offset leg 108 (FIG. 1), second offset leg 110 and third offset leg 112 and radiator housing bottom surface 144. First offset leg 108 (FIG. 1A), second offset leg 110 and third offset leg 112 each bend at the same angle α to rest flat on PCB top surface 152 of PCB 114, such that, when viewed from the side, first offset leg 108 (FIG. 1A), second offset leg 110 and third offset leg 112 are each shaped like a hockey stick so that a portion of the leg is, for example, horizontal and a portion of the leg extends vertically from the horizontal portion of the leg. Persons of skill in the art will note that the use of vertical and horizontal is relative and not limiting. In this embodiment, angle α is approximately 115°. Depending on the geometry and componentry of the mating surface, other angle values are possible in other embodiments. In addition, in alternate embodiments, different angle values for each of first offset leg 108 (FIG. 1), second offset leg 110 and third offset leg 112 are also possible. Further, number and specific geometry and positioning of offset legs may vary in alternate embodiments.

Note the gap 156 created between the PCB top surface 152 and the radiator housing bottom surface 144 which provides clearance for electronic components and/or other physical features on, for example, the PCB as well as space to connect to external electronics, e.g., via coaxial cable. Securement of antenna assembly 100 to PCB 114 is accomplished via one or more bolts 140 passed through apertures in PCB 114 from PCB bottom surface 154 through mating apertures in first offset leg 108 (FIG. 1), second offset leg 110 and third offset leg 112 and secured by nut(s) 142 which engages a bolt 140. Other securement mechanisms, such as screws, can be used without departing from the scope of the disclosure.

FIG. 1D is an isometric drawing of an embodiment of the patch antenna of the disclosure. Evident are elements described in FIG. 1A, including radiator housing 102, radiator plate 104, and feed pin head 106. Together, radiator housing 102, radiator plate 104, and feed pin of which feed pin head, 106 is visible form antenna body 150. Also visible in FIG. 1D, are first offset leg 108 and second offset leg 110, extending from second housing side 120, as well as third offset leg 112. Entire antenna assembly 100 (FIG. 1A) is attached to PCB top surface 152 of PCB 114 via screws via screw(s) 140 passed through apertures in PCB 114 from PCB bottom surface 154 (FIG. 1C) through mating apertures in first offset leg 108, second offset leg 110 and third offset leg 112 and secured by nut(s) 142.

FIG. 2A illustrates an alternate embodiment of the patch antenna of the disclosure which incorporates a ground plane, as viewed from above. Antenna assembly 100, is mounted on PCB 114, as described in FIGS. 1A-1D. Ground plane 202 is a thin planar element, typically fashioned from sheet metal or other suitable conductor to provide grounding for radiator plate 104 (FIG. 1A), having first ground plane side 216, second ground plane side 218, third ground plane side 220, and fourth ground plane side 222, as viewed from above. Ground plane 202 is oriented such that first ground plane side 216 runs parallel to and is nearest first housing side 116, second ground plane side 218 runs parallel to and is nearest second housing side 120, third ground plane side 220 runs parallel to and is nearest third housing side 124, and fourth ground plane side 222 runs parallel to and is nearest fourth housing side 128. Ground plane top surface 204 of ground plane 202 is attached to radiator housing bottom surface 144 (FIG. 1B), typically adhesive or suitable mechanical securement mechanism. Ground plane 202 contains first offset leg aperture 206, second offset leg aperture 208, and third offset leg aperture 210 to facilitate assembly of ground plane 202 and securement of antenna assembly 100 to PCB 114. When viewed from above, first offset leg aperture 206 is positioned such that its perimeter circumscribes that of first offset leg 108 leaving a uniform gap all the way around, second offset leg aperture 208 is positioned such that its perimeter circumscribes that of second offset leg 110 leaving a uniform gap all the way around, and third offset leg aperture 210 is positioned such that its perimeter circumscribes that of third offset leg 112 leaving a uniform gap all the way around, thus enabling ground plane 202 to be attached to antenna assembly 100 and providing access to complete attachment of antenna assembly 100 to PCB 114.

FIG. 2B illustrates an embodiment of the patch antenna of the disclosure which incorporates a ground plane, as viewed from below. Visible details include ground plane bottom surface 224 of ground plane 202. Within the perimeter of ground plane 202 are first offset leg aperture 206, second offset leg aperture 208 and third offset aperture 210 as described in FIG. 2A. Also visible are first offset leg 108, second offset 110 and third offset leg 112 as well as screw(s) 140 as described in FIGS. 1A-1D. Centrally located within ground plane 202 is ground plane feed pin shank aperture 226 through which passes feed pin shank 148. Coaxial cable 212 provides connection to external electronics via center conductor 214 which is attached, typically either mechanically or via solder joint, to feed pin shank 148.

FIG. 2C illustrates an embodiment of the patch antenna of the disclosure which incorporates a ground plane 202, as viewed from the side. Visible are third housing corner 126 fourth housing side 128 and fourth housing corner 130 of antenna body 150. First offset leg 108, second offset leg 110 and third offset leg 112 extend downward from antenna body 150 to PCB 114 upon which the entire antenna assembly 100 (FIG. 1A) is mounted. Ground plane top surface 204 of ground plane 202 reside flush against radiator housing bottom surface 148 (FIG. 1C). Note gap 156 between PCB top surface 152 and ground plane bottom surface 224 which is a space that provides clearance for electronic components and/or other physical features on PCB as well as space for coaxial cable 212 to connect to external electronics.

FIG. 2D is an isometric drawing of an embodiment of the patch antenna of the disclosure which incorporates a ground plane. Evident is antenna assembly 100 as described in FIG. 1A, secured to PCB 114. The PCB 114 is part of the electronics of the device which incorporates the disclosed antenna assembly 100. Of note, is ground plane 202 with first offset leg aperture 206, second offset leg aperture 208, and third offset leg aperture 210 as described in detail in FIG. 2A. Also visible is coaxial cable 212, which provides connection to external electronics, extending from beneath ground plane 202.

FIG. 3A illustrates an alternate embodiment of the patch antenna of the disclosure as viewed from above. Antenna body 150 is as described in FIGS. 1A-1D, with features including radiator housing 102, radiator plate 104, feed pin head 106, first housing side 116, second housing side 120, third housing side 124, and fourth housing side 128. As viewed from above, first snap-fit leg 302 and second snap-fit leg 304 extend perpendicular from second housing side 120. First snap-fit leg 302 is located near first housing corner 118; second snap-fit leg 304 is located near second housing corner. Located opposite second housing side 120, third snap-fit-leg 306 extends perpendicular from the center of fourth housing side 128, as viewed from above. As such, first snap-fit leg 302, second snap fit leg 304, and third snap-fit leg 306 form a tripod base upon which radiator housing 102 rests, thus providing space beneath for existing electronics and componentry.

FIG. 3B illustrates an alternate embodiment of the patch antenna of the disclosure as viewed from below. Evident are features described in FIGS. 1A-1D, including antenna body 150, radiator housing bottom surface 144, feed pin aperture 146, and feed pin shank 148. First snap-fit leg 302 and second-snap-fit leg 304 extend perpendicular from second housing side 120 and are positioned, respectively, near first housing corner 118 and second housing corner 122. Third snap-fit leg 306 extends perpendicular from the middle of fourth housing side 128, opposite both first snap-fit leg 302 and second snap-fit leg 304.

FIG. 3C illustrates an alternate embodiment of the patch antenna of the disclosure as viewed from the side, looking directly at second housing side 120. Evident are features first described in FIGS. 1A-1D, including antenna body, feed pin head 106, and feed pin shank 148. Extending downward from antenna body 150 on second housing side 120, are first snap-fit leg 302 and second snap-fit leg 304. Also partially visible is third snap-fit leg 306, extending downward from antenna body 150. At the end of first snap-fit leg 302 is first snap-fit foot 308; at the end of second snap-fit leg 304 is second snap-fit foot 310; and at the end of third snap-fit leg 306 is third snap-fit foot 312. First snap-fit foot 308, second snap-fit foot 310 and third snap-fit foot 312 are identical in geometry and construction; each takes the form of a two-pronged fork wherein each prong is barbed such that when pressed with sufficient force through an appropriately-sized aperture, the prongs deform to allow passage; once through the aperture the prongs spring back to their original geometry whereupon the barbs provide securement via the backside surface of the aperture.

FIG. 3D is an isometric drawing of an embodiment of the patch antenna of the disclosure. Visible is antenna body 150, including radiator housing 102 radiator plate 104 and feed pin head 106 as described in detail in FIGS. 1A-1D. Extending from second housing side 120 are first snap-fit leg 302 and second snap-fit-leg 304. Note that in this embodiment, first snap-fit leg 302, second snap-fit leg 304 and third snap-fit leg 306 (FIG. 3A) extend downward and outward at an angle from radiator housing 102. In other embodiments, different geometries may be employed depending on, for example mounting surface details.

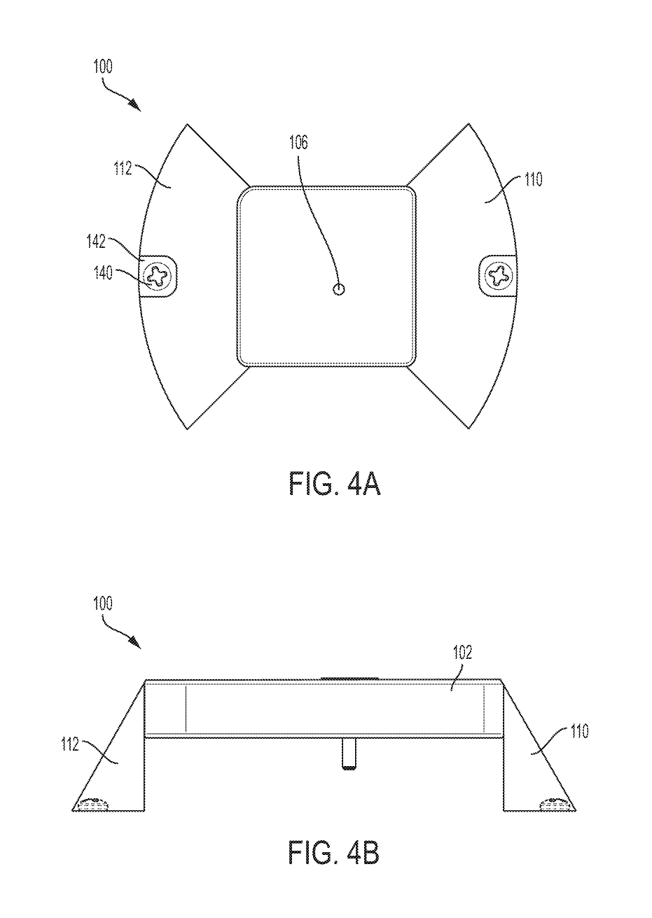

Turning to FIGS. 4A-B, an antenna assembly 100 is shown which has a radiator housing 102 and a feed pin head 106. A first leg 110 and a second leg 112 are provided. As illustrated each of the first leg 110 and the second leg 112 has a length that is commensurate with, or substantially commensurate with, the length of the radiator housing 102 to which the leg is attached. A suitable attachment mechanism, such as a bolt 140 can be provided which passes through an aperture in the leg to secure the radiator housing 102 in a raised position from the PCB (shown in FIG. 1A).

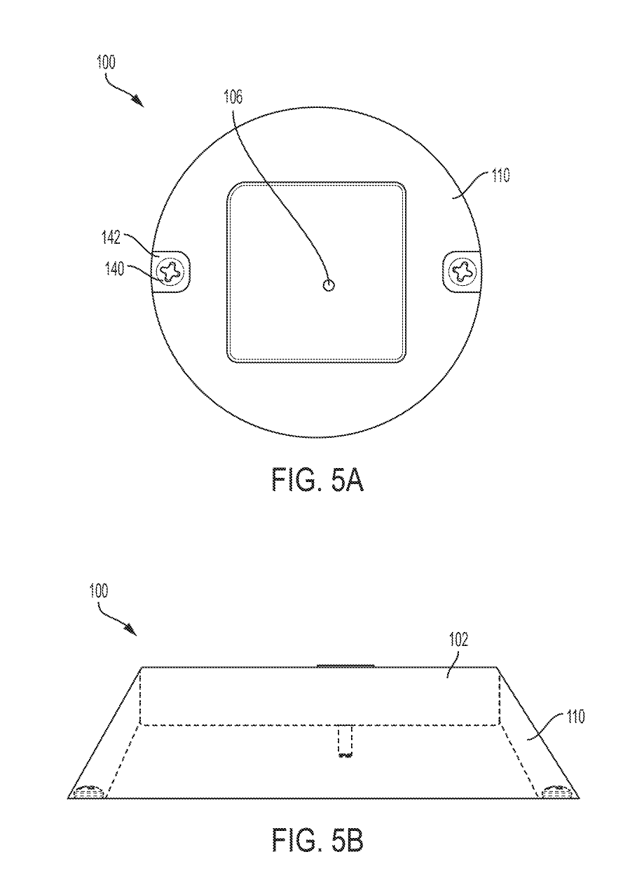

As shown in FIGS. 5A-B, an antenna assembly 100 is shown which has a radiator housing 102 and a feed pin head 106. A single leg 110 is provided which encircles the exterior of the radiator housing 102. A suitable attachment mechanism, such as a bolt 140 can be provided which passes through an aperture in the leg to secure the radiator housing 102 in a raised position from the PCB (shown in FIG. 1A).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A patch antenna comprising:
a radiator housing having an upper surface, a lower surface, and four sides between the upper surface and lower surface wherein the upper surface faces away from an installation substrate and the lower surface faces towards the installation substrate when installed;
a radiator plate on the upper surface of the radiator housing;
a feed pin which passes through the radiator housing and terminates in a feed pin head on the upper surface of the radiator housing;
a leg which extends from the radiator housing beyond the lower surface of the radiator housing wherein the leg creates a gap between the lower surface of the radiator housing and a bottom of the leg.

2. The patch antenna of claim 1 wherein the radiator housing is formed from a dielectric material.

3. The patch antenna of claim 1 further comprising one or more of feet, standoffs, posts, and bosses.

4. The patch antenna of claim 1 further comprising a first offset leg, a second offset leg, and a third offset leg which extend from the radiator housing beyond the lower surface of the radiator housing wherein two of the offset legs extend from the radiator housing at a location along a first axis and the third offset leg extends from the radiator housing a location along a second axis which is parallel to the first axis.

5. The patch antenna of claim 1 further comprising one or more threaded fasteners which pass through an aperture in the offset leg.

6. The patch antenna of claim 1 further comprising a ground plane element positioned adjacent the lower surface of the radiator housing.

7. The patch antenna of claim 6 wherein the three offset legs pass through a corresponding aperture of the ground plane element.

8. The patch antenna of claim 1 wherein the patch antenna engages an electronic device.

9. The patch antenna of claim 8 wherein the patch antenna engages the electronic device via a coaxial cable.

10. A method of installing a patch antenna comprising:
providing the patch antenna comprising a radiator housing having an upper side and a lower side where the upper side faces away from a PCB and the lower side faces towards the PCB when installed, a radiator plate on the upper surface of the radiator housing, a feed pin which passes through the radiator housing and terminates in a feed pin head on the upper surface of the radiator housing, a leg which extends from the radiator housing beyond the lower surface of the radiator housing wherein the leg creates a gap between the lower surface of the radiator housing and a bottom of the leg;
positioning the patch antenna on a substrate so that the lower surface of the housing does not contact the substrate;
securing the patch antenna to a substrate; and
connecting the patch antenna to an electronic device.

11. The method of installing the patch antenna of claim 10, further comprising securing the patch antenna to the substrate with a threaded fastener.

12. The method of installing the patch antenna of claim 10, further comprising securing the patch antenna to the substrate with an adhesive.

13. The method of installing the patch antenna of claim 10, further comprising securing via a press-fit or friction-fit.

14. The method of installing the patch antenna of claim 10, further comprising positioning a ground plane element adjacent the radiator housing prior to securing the patch antenna to the substrate.

15. A patch antenna comprising:
a radiator housing means having an upper surface, a lower surface, and four sides between the upper surface and lower surface wherein the upper surface faces away from an installation substrate means and the lower surface faces towards the installation substrate means when installed;
a radiator plate on the upper surface of the radiator housing means;
a feed pin which passes through the radiator housing means and terminates in a feed pin head on the upper surface of the radiator housing means;
a leg which extends from the radiator housing beyond the lower surface of the radiator housing wherein the leg creates a gap between the lower surface of the radiator housing and a bottom of the leg.

16. The patch antenna of claim 15 wherein the radiator housing means is formed from a dielectric material.

17. The patch antenna of claim 15 further comprising one or more of feet, standoffs, posts, and bosses.

18. The patch antenna of claim 15 further comprising a gap between the lower surface of the radiator housing means and a bottom of the offset leg.

19. The patch antenna of claim 15 further comprising one or more threaded fasteners which pass through an aperture in the offset leg.

20. The patch antenna of claim 15 further comprising a ground plane element positioned adjacent the lower surface of the radiator housing means.

21. The patch antenna of claim 20 wherein the three offset legs pass through a corresponding aperture of the ground plane element.

22. The patch antenna of claim 15 wherein the patch antenna engages an electronic device.

23. The patch antenna of claim 22 wherein the patch antenna engages the electronic device via a coaxial cable.
